(19) United States
(12) Patent Application Publication
(10) Pub. No.: US 2006/0284441 A1
(43) Pub. Date: Dec. 21, 2006

(54) Assembly for carrying a load

(76) Inventor: Hugo Blanchette, Brownsburg-Chatham (CA)

Correspondence Address: Louis Tessier, P.O.Box 54029, Town of Mount-Royal, QC, H3P 3H4, CA

(21) Appl. No.: 11/414,270

(22) Filed: May 1, 2006

Related U.S. Application Data
(60) Provisional application No. 60/691,293, filed on Jun. 17, 2005.

(51) Int. Cl. B60J 11/00

(52) U.S. Cl. 296/98

(57) ABSTRACT

An assembly for carrying a load, the assembly including a container for containing the load, the container defining a top aperture, the top aperture defining an aperture first end and a substantially opposed aperture second end, the container including a container bottom wall located substantially opposite the top aperture; and a substantially elongated tarpaulin attached to the container and extending at least in part substantially in register with the top aperture, the tarpaulin defining a tarpaulin first end and a substantially longitudinally opposed tarpaulin second end, the tarpaulin first end being located substantially adjacent the aperture first end and the tarpaulin second end being located substantially adjacent the aperture second end, a tarpaulin first concave section located substantially adjacent the tarpaulin first end, the tarpaulin first concave section being located substantially closer to the container bottom wall than the tarpaulin first end, a tarpaulin second concave section located substantially adjacent the tarpaulin second end, the tarpaulin second concave section being located substantially closer to the container bottom wall than the tarpaulin second end, and a tarpaulin convex section located between the tarpaulin first and second concave sections.

This application claims priority from US Provisional patent application Serial No. 60/691,293 filed Jun. 17, 2005.

### FIELD OF THE INVENTION

The present invention relates to the general field of transportation. More specifically, the present invention is concerned with an assembly for carrying a load.

### BACKGROUND OF THE INVENTION

Dump trucks have a body into which a load is carried, the body having an upper aperture. In some cases, the load releases substances, such as for example dust, when the dump truck moves. For instance, these substances are released because of aerodynamic forces exerted by the flow of air on the load. Also, these substances may be released because of shocks transmitted to the load when the truck hits road imperfections. In other cases, vapors or heat may be released by the load through the upper aperture.

Many jurisdictions require that some types of loads, such as for example sand or asphalt loads, be covered with a suitable material so as to minimize the release of undesirable substances into the environment. Typically, this result is achieved by positioning over the upper aperture a tarpaulin that substantially prevents the release into the environment of parts of the load.

However, such tarpaulin may be loosely fitted onto the upper aperture and may include holes to allow air to pass therethrough. These holes are provided to reduce possibilities that the material may be torn apart by aerodynamic forces exerted onto the tarpaulin when the dump truck is moving. Since these materials are typically loosely fitted onto the upper aperture, there is a risk that at least part of the undesired substances are released from the dump truck as they pass between the rim of the aperture and the material.

In addition, the tarpaulins are typically extended over the load using arms that are pivotally attached to the body. Pivoting the arms from the front of the truck towards the rear of the truck pulls onto a tarpaulin rolled around a rod. These arms are often relatively long. Therefore, if the air flowing around the tarpaulin exerts a force onto the tarpaulin while the truck moves, there is a risk that the tarpaulin will exert forces onto the arms sufficient to damage them.

Against this background, there exists a need in the industry to provide a novel assembly for carrying a load. An object of the present invention is therefore to provide an improved assembly for carrying a load.

### SUMMARY OF THE INVENTION

In a first broad aspect, the invention provides a device for maintaining a tarpaulin substantially in register with a top aperture of a container, the top aperture defining an aperture first end and a substantially opposed aperture second end, the container including a container bottom wall located substantially opposite the top aperture, the tarpaulin being configurable between a tarpaulin extended configuration and a tarpaulin retracted configuration, wherein, in the tarpaulin extended configuration, the tarpaulin is at least in part substantially in register with the top aperture, and in the tarpaulin retracted configuration, the tarpaulin is substantially retracted from the top aperture, the tarpaulin defining a tarpaulin first end and a substantially opposed tarpaulin second end, the tarpaulin first and second ends being respectively located substantially adjacent the aperture first and second ends when the tarpaulin is in the tarpaulin extended configuration. The device includes:
a tarpaulin receiving implement located substantially adjacent the aperture first end, the tarpaulin receiving implement being mechanically coupled to the tarpaulin for receiving the tarpaulin when configuring the tarpaulin from the tarpaulin extended configuration to the tarpaulin retracted configuration and for releasing the tarpaulin when configuring the tarpaulin from the tarpaulin retracted configuration to the tarpaulin extended configuration; and
a tarpaulin biasing component mechanically coupled to the container and to the tarpaulin for biasing a tarpaulin section located substantially adjacent said tarpaulin second end such that the tarpaulin section is located substantially closer to the container bottom wall than the tarpaulin second end when the tarpaulin is in the tarpaulin extended configuration.

In another broad aspect, the invention provides a method for maintaining a tarpaulin substantially in register with a top aperture of a container carried by a forwardly moving vehicle moving through air, the top aperture defining an aperture rear end and a substantially opposed aperture front end, the container including a container bottom wall located substantially opposite the top aperture, the tarpaulin defining a tarpaulin front end and a substantially opposed tarpaulin rear end. The method includes:
extending the tarpaulin substantially across the top aperture such that the tarpaulin front end is located substantially adjacent the aperture front end and the tarpaulin rear end is located substantially adjacent the tarpaulin rear end; and
biasing a tarpaulin section located substantially adjacent the tarpaulin rear end such that the tarpaulin section is located substantially closer to the container bottom wall than the tarpaulin second end.

In yet another broad aspect, the invention provides an assembly for carrying a load, the assembly including:
a container for containing the load, the container defining a top aperture, the top aperture defining an aperture first end and a substantially opposed aperture second end, the container including a container bottom wall located substantially opposite the top aperture; and
a substantially elongated tarpaulin attached to the container and extending at least in part substantially in register with the top aperture, the tarpaulin defining
a tarpaulin first end and a substantially longitudinally opposed tarpaulin second end, the tarpaulin first end being located substantially adjacent the aperture first end and the tarpaulin second end being located substantially adjacent the aperture second end;
a tarpaulin first concave section located substantially adjacent the tarpaulin first end, the tarpaulin first concave section being located substantially closer to the container bottom wall than the tarpaulin first end;
a tarpaulin second concave section located substantially adjacent the tarpaulin second end, the tarpaulin second concave section being located substantially closer to the container bottom wall than the tarpaulin second end; and
a tarpaulin convex section located between the tarpaulin first and second concave sections.

The aperture first and second ends define a longitudinal direction leading from the aperture first end to the aperture second end. Similarly, the aperture front and rear ends also define a longitudinal direction leading from the aperture rear end to the aperture front end. In some embodiments of the invention, the tarpaulin is configured such that when the tarpaulin is in the tarpaulin extended configuration and the container is moving through air in the longitudinal direction, the air exerts a force onto the tarpaulin that biases at least a section of the tarpaulin towards the container bottom wall.

Advantageously, the device and assembly are relatively easy to use and relatively easy to manufacture. In addition, the device and assembly are, in some embodiments of the invention, retrofittable to existing vehicles.

The device and assembly are also relatively inexpensive to manufacture and reduces the quantity of undesired materials released into the environment by the load contained in the body of the dump truck.

In some embodiments of the invention, the tarpaulin is suitable for sealing the load into the body. In these embodiments, this seal helps in reducing the emission of undesired vapors into the environment. Also, in these embodiments the tarpaulin contributes to maintaining the temperature of warm or hot loads, such as for example of asphalt loads.

In embodiments wherein air moving over the container produce a force biasing at least in part the tarpaulin towards the container bottom wall, this force reduce risks that the device may be damaged by undesirable movements of the tarpaulin caused by the air.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a perspective view, illustrates an assembly for carrying a load in accordance with an embodiment of the present invention, the assembly including a container and a tarpaulin attached to the container, the tarpaulin being shown in an extended configuration.

FIG. 2A, in a top plan view, illustrates the assembly of FIG. 1, the tarpaulin being shown in the extended configuration;

FIG. 2B, in a side elevation view, illustrates the assembly of FIG. 1, the tarpaulin being shown in the extended configuration;

FIG. 3A, in a top plan view, illustrates the assembly of FIG. 1, the tarpaulin being shown in a configuration intermediate the extended configuration and a retracted configuration;

FIG. 3B, in a side elevation view, illustrates the assembly of FIG. 1, the tarpaulin being shown in the configuration intermediate the extended configuration and the retracted configuration;

FIG. 4A, in a top plan view, illustrates the assembly of FIG. 1, the tarpaulin being shown in the retracted configuration; and

FIG. 4B, in a side elevation view, illustrates the assembly of FIG. 1, the tarpaulin being shown in the retracted configuration;

FIG. 5A, in a top plan view, illustrates an assembly for carrying a load in accordance with an alternative embodiment of the present invention, the assembly including a container and a tarpaulin attached to the container, the tarpaulin being shown in an extended configuration;

FIG. 5B, in a side elevation view, illustrates the assembly of FIG. 5A, the tarpaulin being shown in the extended configuration.

### DETAILED DESCRIPTION

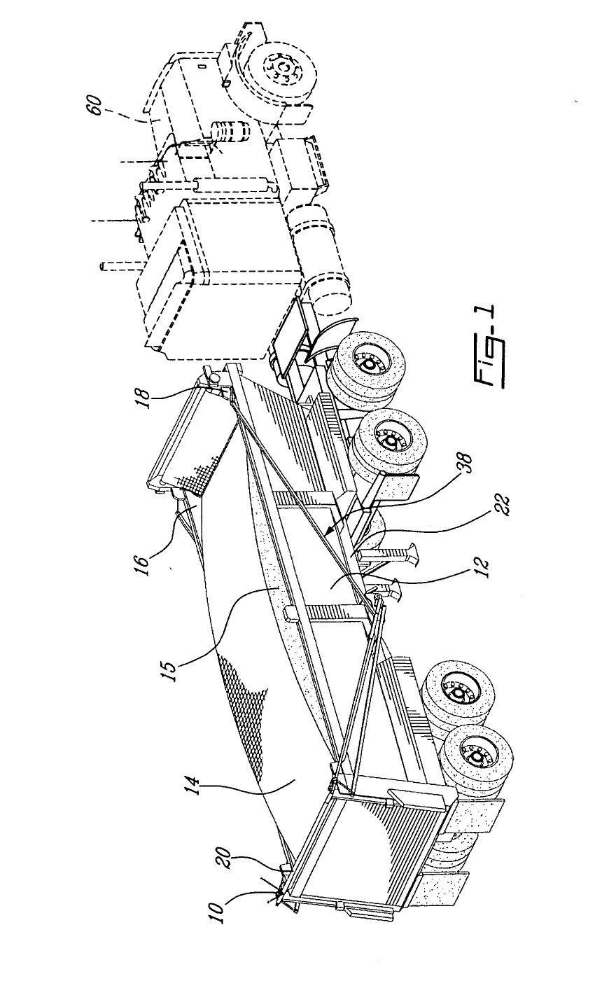

FIG. 1 illustrates an assembly 10 for carrying a load 15 in accordance with an embodiment of the present invention. The assembly 10 includes a container 12 for containing the load 15. In addition, the assembly 10 includes a substantially elongated tarpaulin 14 attached to the container 12. In some embodiments of the invention, as further described hereinbelow, a device 38 maintains the tarpaulin 14 substantially in register with a top aperture 16 of the container 12.

For the purpose of this specification, the term tarpaulin should be understood to include tarpaulins per se, canvas, webs and any other suitable fabric that has a capability of retaining at least in part particles, liquids, gases, or any combination thereof.

The top aperture 16 defines an aperture first end 18 and a substantially longitudinally opposed aperture second end 20. Furthermore, the container 12 includes a container bottom wall 22 located substantially opposite the top aperture 16.

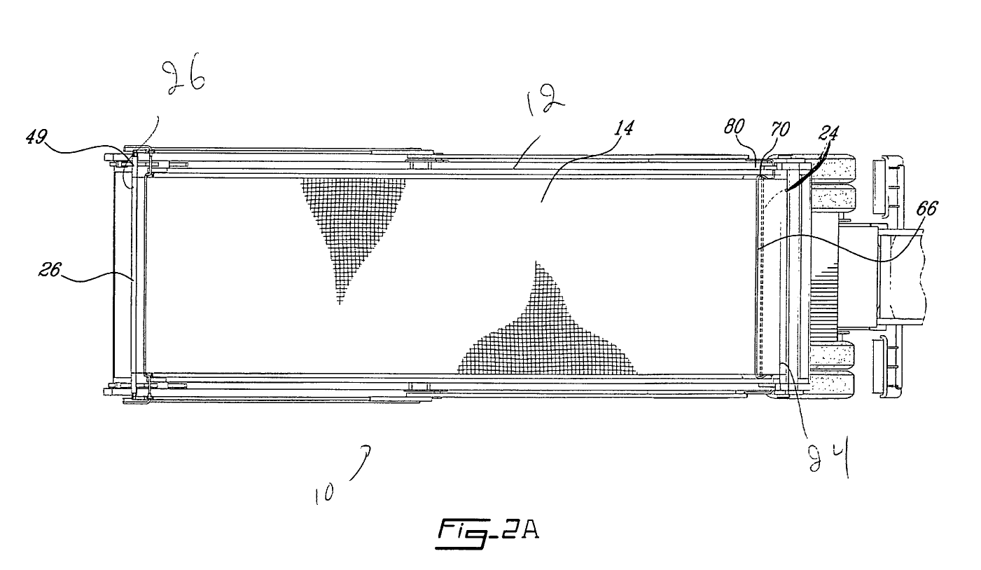

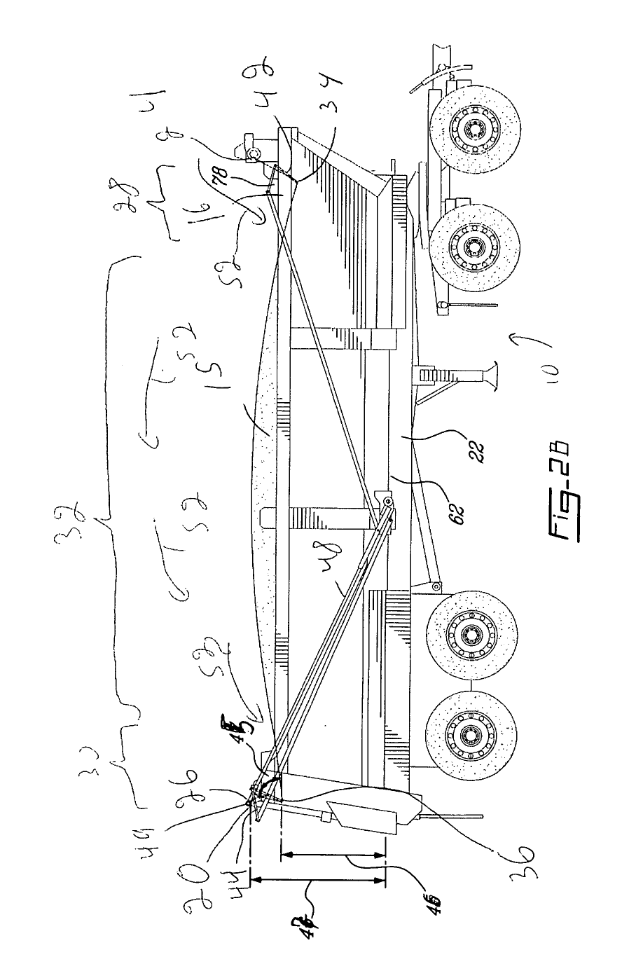

Referring to FIGS. 2A and 2B, the tarpaulin 14 extends, at least in part, substantially in register with the top aperture 16. The tarpaulin 14 defines a tarpaulin first end 24 and a substantially longitudinally opposed tarpaulin second end 26. In addition, the tarpaulin 14 defines a tarpaulin first concave section 28, a tarpaulin second concave section 30 and a tarpaulin convex section 32. The tarpaulin first and second concave sections 28 and 30 are also referred to respectively as a first and a second concavity.

The tarpaulin first concave section 28 is located substantially adjacent the tarpaulin first end 24. The tarpaulin first concave section 28 is also located substantially closer to the container bottom wall 22 than the tarpaulin first end 18. The tarpaulin second concave section 30 is located substantially adjacent the tarpaulin second end 26. The tarpaulin second concave section 30 is also located substantially closer to the container bottom wall 22 than the tarpaulin second end 26. The tarpaulin convex section 32 is located between the tarpaulin first and second concave sections 28 and 30. In addition, the tarpaulin first and second concave sections 28 and 30 define respectively a first nadir 34 and a second nadir 36.

Although the tarpaulin 14 seen in the drawings defines two tarpaulin concave sections 28 and 30, in some embodiments of the invention, only one of the concave sections 28 and 30 is defined by the tarpaulin 14.

In some embodiments of the invention, the second nadir 36 is substantially longitudinally closer to the aperture second end 20 than the tarpaulin second end 26. For example, and non-limitingly, it has been found that having an angle 45 between the container bottom wall 22 and the portion of the tarpaulin 14 extending between the tarpaulin second end 26 and the second nadir 36 of between about 55 degrees and 85 degrees results in air exerting a force onto the tarpaulin 14 that biases the tarpaulin second concave section 28 towards the container bottom wall 22 when the container is moved through air in a longitudinal direction leading from the aperture second end 20 to the aperture first end 18. In a specific example of implementation, the angle 45 takes a value of about 65 degrees.

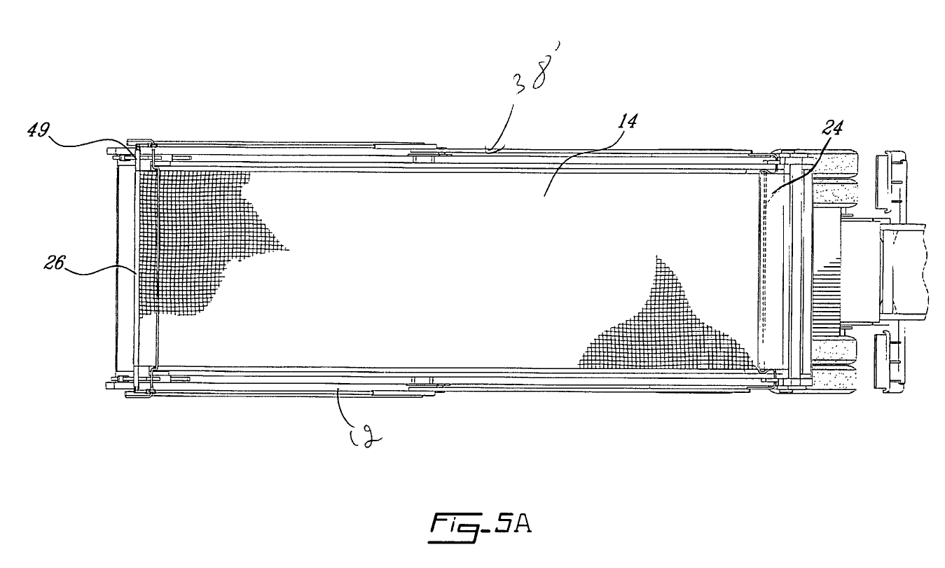

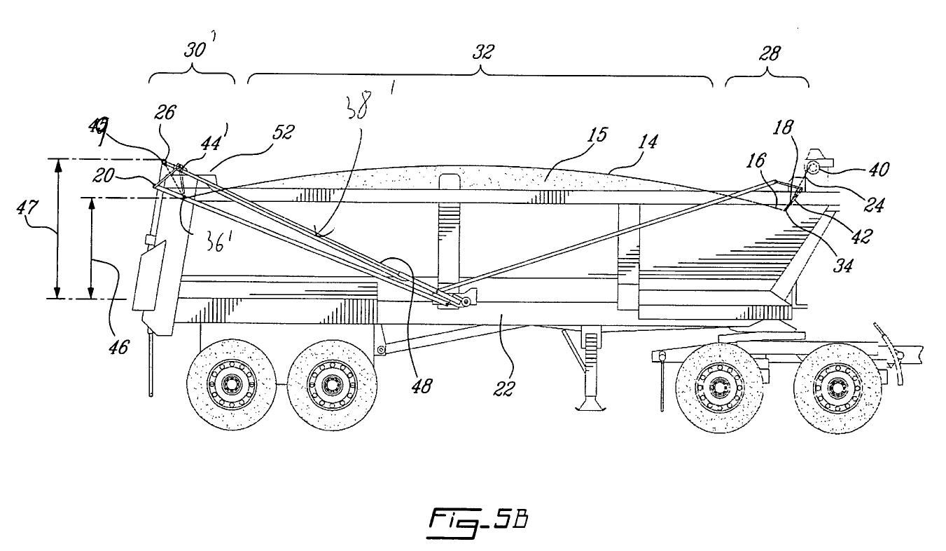

While a specific configuration of the tarpaulin 14 leading to the above-described exertion of a force onto the tarpaulin 14 is shown in the drawings, the reader skilled in the art will readily appreciate that any other suitable tarpaulin configuration wherein a tarpaulin section substantially adjacent the tarpaulin second end 26 is located substantially closer to the container bottom wall 22 than the tarpaulin second end 26 may achieve the same effect. For example, FIGS. 5A and 5B illustrate such an alternative embodiment wherein and alternative device 38′ maintains the tarpaulin 14 in alternative extended configuration. In this embodiment, a second nadir 36′ is substantially longitudinally further from the aperture second end 20 than the tarpaulin second end 26. In the present documents, reference numerals to which a′ has been appended refer to the embodiment illustrated in FIGS. 5A and 5B while reference numerals that do not include a′ refer to similar components in the embodiment of the invention illustrated in FIGS. 1-4B.

In some embodiments of the invention, the tarpaulin 14 is substantially planar between the second nadir 36 and the tarpaulin second end 26. Furthermore, the tarpaulin may be also substantially planar between the first nadir 34 and the tarpaulin first end 24.

In some embodiments of the invention, the tarpaulin convex section 32 is substantially arc segment-shaped. For example, and non-limitingly, the tarpaulin convex section 32 may be formed by abutting the tarpaulin convex section 32 against the load 15. Typically, but non-limitingly, this is achieved for heaped loads. However, in alternative embodiments of the invention, the shape of the tarpaulin convex section is achieved by suitably securing the tarpaulin 14 to the container 12.

In some embodiments of the invention, a nadir-to-bottom wall distance 46 between the second nadir 36 and the container bottom wall 22 is from about 50% to about 90% of a second end-to-bottom wall distance 47 between the tarpaulin second end 26 and the container wall 22. In a specific example of implementation, the nadir-to-bottom wall distance 46 is about 80% of the second end-to-bottom wall distance 47. The above-mentioned relationship between the nadir-to-bottom wall distance 46 and the second end-to-bottom wall distance 47 has been found in some embodiments of the invention to provide good results while maintaining fuel consumption of a vehicle carrying the container 12 at a reasonable level. However, it is within the scope of the invention to have any other suitable relationship between these two distances 46 and 47.

In some embodiments of the invention, the above-described configuration of the tarpaulin 14 is maintained using the device 38, which is described in further detail hereinbelow. However, in alternative embodiments of the invention, this configuration of the tarpaulin 14 is maintained in any other suitable manner. For example, the tarpaulin 14 may be secured to the container 12 through attachments located substantially adjacent the first nadir 34 and the second nadir 36 that extend towards and are attached to the container bottom wall 22. In other embodiments of the invention, weights may be disposed onto the tarpaulin 14 at locations substantially adjacent the first and second nadirs 34 and 36 so as to create the first and second tarpaulin concave sections 28 and 30.

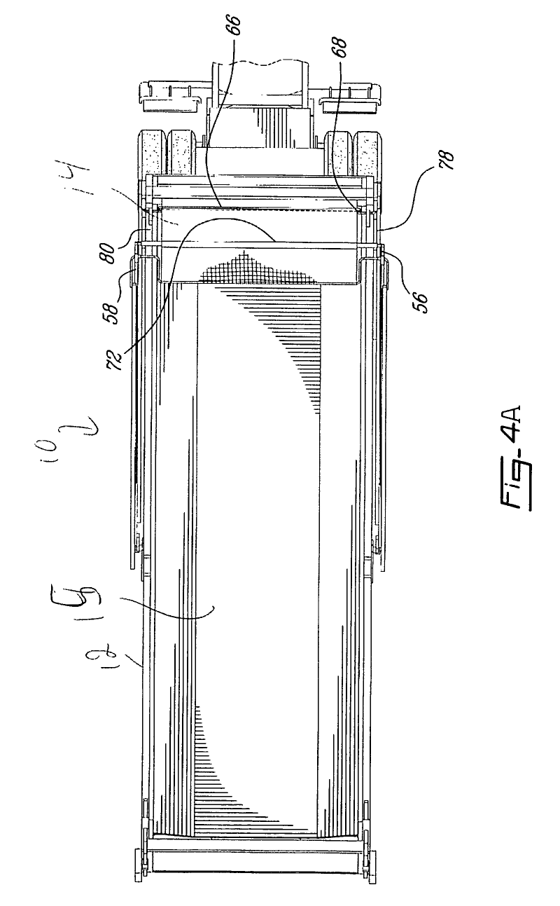

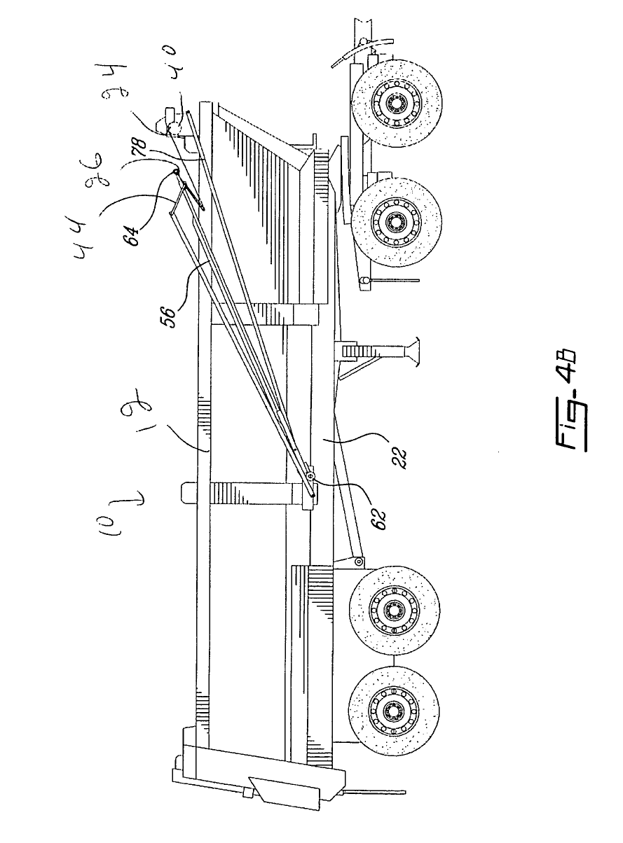

The device 38 maintains the tarpaulin 14 substantially in register with the top aperture 16. The tarpaulin 14 is configurable between a tarpaulin extended configuration, as seen in FIGS. 2A and 2B, and a tarpaulin retracted configuration, as seen in FIGS. 4A and 4B. In the tarpaulin extended configuration, the tarpaulin 14 is at least in part substantially in register with the top aperture 12, and in the tarpaulin retracted configuration, the tarpaulin 14 is substantially retracted from the top aperture 12. Furthermore, in the tarpaulin extended configuration, the tarpaulin first and second ends 24 and 26 are respectively located substantially adjacent the aperture first and second ends 18 and 20.

The device 38 includes a tarpaulin receiving implement 40 located substantially adjacent the aperture first end 18, the tarpaulin receiving implement 40 being mechanically coupled to the tarpaulin 14 for receiving the tarpaulin 14 when configuring the tarpaulin 14 from the tarpaulin extended configuration to the tarpaulin retracted configuration and for releasing the tarpaulin 14 when configuring the tarpaulin 14 from the tarpaulin retracted configuration to the tarpaulin extended configuration.

The device 38 further includes a tarpaulin first biasing component 42 for biasing the tarpaulin first concave section 28 such that the tarpaulin first concave section 28 is located substantially closer to the container bottom wall 22 than the tarpaulin first end 18. Similarly, the device 38 includes a tarpaulin second biasing component 44 for biasing the tarpaulin second concave section 20 such that the tarpaulin second concave section 30 is located substantially closer to the container bottom wall 22 than the tarpaulin second end 26.

It should be noted that, in alternative embodiments of the invention, the tarpaulin first and second biasing components 42 and 44 may bias any suitable tarpaulin sections located substantially adjacent the tarpaulin first and second ends 24 and 26 such that they are respectively substantially closer to the container bottom wall 22 than the tarpaulin first and second ends 24 and 26.

In addition, in some embodiments of the invention, only one of the tarpaulin first and second biasing components 42 and 44 is provided. In these embodiments of the invention, the tarpaulin concave section corresponding to the missing tarpaulin biasing component is either not concave or is shaped to form a concavity in any other suitable manner.

The tarpaulin first and second biasing components 42 and 44 are positionable between respective tarpaulin first and second biasing positions and respective tarpaulin first and second releasing positions. In the tarpaulin first and second biasing positions, the tarpaulin first and second biasing components 42 and 44 respectively bias the tarpaulin first and second concave sections 28 and 30 such that the tarpaulin first and second concave sections 28 and 30 are respectively located substantially closer to the container bottom wall 22 than the tarpaulin first and second ends 24 and 26. The tarpaulin biasing position is illustrated in FIGS. 2A and 2B.

In the tarpaulin releasing position, the tarpaulin first and second biasing components 42 and 44 respectively release the tarpaulin first and second concave sections 28 and 30 such that the tarpaulin is movable towards the tarpaulin retracted configuration, illustrated in FIGS. 4A and 4B.

In some embodiments of the invention, the tarpaulin first and second biasing components 42 and 44 are operable independently from each other. In other embodiments of the invention, the device 38 further includes a tarpaulin actuator 48 mechanically coupled to the container 12 and to the tarpaulin 14 for moving the tarpaulin 14 between the tarpaulin extended and retracted configurations.

The tarpaulin actuator 48 includes a second end holder 49 for holding the tarpaulin second end 26 substantially adjacent the aperture second end 26 when the tarpaulin 14 is in the tarpaulin extended configuration. The tarpaulin first end 24 is maintained substantially adjacent the aperture first end 18 by the tarpaulin receiving implement 40.

In some embodiments of the invention, one of the tarpaulin first and second biasing components 42 and 44 is operatively coupled to the tarpaulin actuator 48 such that when the tarpaulin actuator 48 moves the tarpaulin 14 towards the tarpaulin extended configuration, one of the tarpaulin first and second biasing components 42 and 44 moves towards the tarpaulin biasing position corresponding to the tarpaulin biasing component that is coupled to the tarpaulin actuator 48.

In some embodiments of the invention, the tarpaulin first and second biasing components 42 and 44 are together movable between a tarpaulin biasing configuration and a tarpaulin releasing configuration. The tarpaulin biasing configuration corresponds to a configuration wherein the tarpaulin first and second biasing components 42 and 44 are respectively in the tarpaulin first and second biasing positions. In the tarpaulin releasing configuration, the tarpaulin first and second biasing components 42 and 44 are respectively in the tarpaulin first and second releasing positions. For example, the tarpaulin first and second biasing components 42 and 44 are operatively coupled to the tarpaulin actuator 48 such that when the tarpaulin actuator 48 moves the tarpaulin 14 towards the tarpaulin extended configuration, the tarpaulin first and second biasing components 42 and 44 move respectively towards the tarpaulin first and second biasing configurations.

Therefore, in this embodiments of the invention, simply actuating the tarpaulin actuator 48 to move the tarpaulin substantially in register with the top aperture 16 results in the tarpaulin first and second biasing components 42 and 44 to automatically achieve their respective tarpaulin biasing positions. Accordingly, a single operation allows to create the tarpaulin first and second concave sections 28 and 30 and the tarpaulin convex section 32 while, at the same time, moving the tarpaulin 14 into the tarpaulin extended configuration. It is therefore relatively simple to achieve the configuration of the tarpaulin 14 illustrated in FIGS. 2A and 2B and impossible for an intended user to forget to move the tarpaulin first and second biasing components 42 and 44 respectively towards the tarpaulin first and second biasing positions.

However, in alternative embodiments of the invention, the tarpaulin first and second biasing components 42 and 44 may be operated independently from a tarpaulin actuator 48. In other alternative embodiments of the invention, no tarpaulin actuator 48 is provided and the tarpaulin 14 is secured to the container 12 in any other suitable manner.

The above therefore suggests a method for maintaining a tarpaulin 14 substantially in register with the top aperture 12 of a container 14. The container 14 may be carried by a forwardly moving vehicle 60 (seen in FIG. 1) moving through air 52. The top aperture 12 defines an aperture rear end, corresponding to the aperture second end 20, and a substantially opposed aperture front end, corresponding to the tarpaulin first end 24. The method includes extending the tarpaulin 14 substantially across the top aperture 14 and biasing a tarpaulin section located substantially adjacent the tarpaulin rear end, which corresponds to the tarpaulin second end 22 such that the tarpaulin section is located substantially closer to the container bottom wall 22 than the tarpaulin rear end 26.

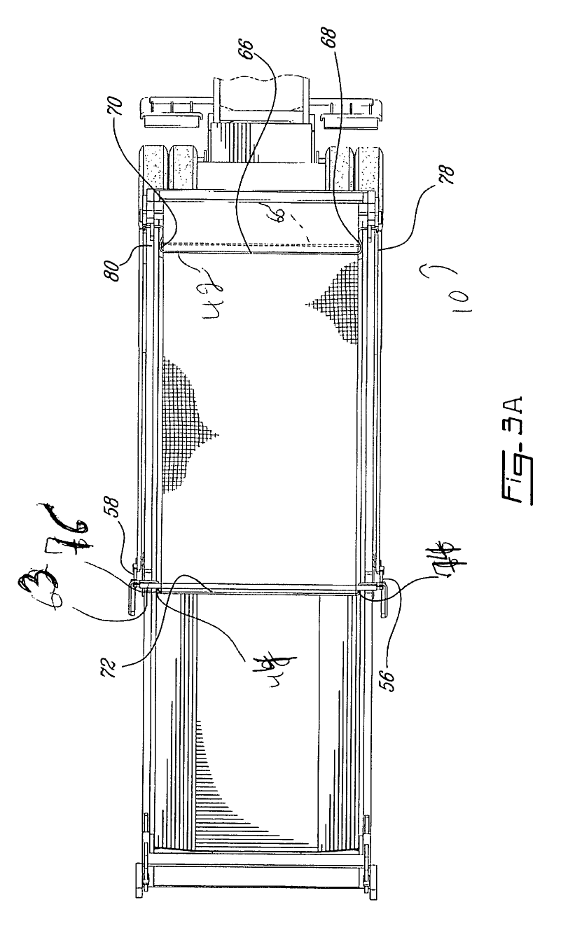

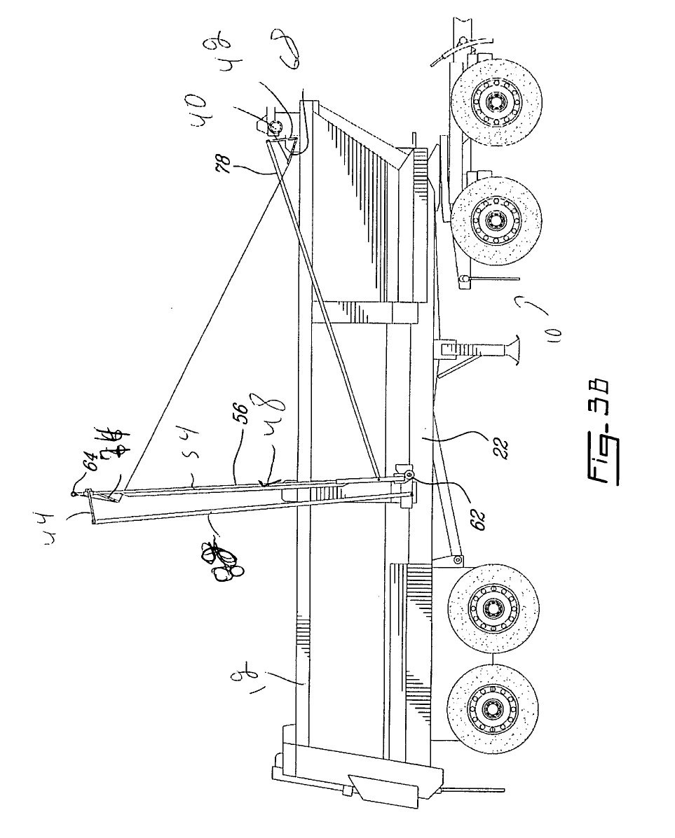

With reference to FIGS. 3A and 3B, wherein the tarpaulin 14 is illustrated in a configuration intermediate the tarpaulin extended and retracted configurations, the device 38 in described hereinbelow in further details. The device 38′ shown in FIGS. 5A and 5B is substantially similar to the device 38 and is therefore not described in great details. A difference existing between the device 38 and the device 38′ resides in that to form an alternative tarpaulin second concave section 30′ in the tarpaulin 14, the device 38′ includes an alternative tarpaulin second biasing component 44′ having a configuration that differs from the configuration of the tarpaulin second biasing component 44. The second biasing component 44′

Returning to FIGS. 3A and 3B, the tarpaulin actuator 48 includes an actuating arm 54. The actuating arm 54 is substantially U-shaped and includes first and second actuating arms side portions 56 and 58 provided outside of the body 14. An interconnecting rod 63 acting as the second end holder 49 interconnects the first and second actuating arm side portions 56 and 58.

More specifically, as better illustrated in FIG. 3B, the first actuating arm side portion 56 defines a first actuating arm side portion first end 62 and a longitudinally opposed first actuating arm side portion second end 64. Similarly, although not clearly seen in the drawings, the second actuating arm side portion 58 defines a second actuating arm side portion first end and a longitudinally opposed second actuating arm side portion second end. The first and second actuating arms side portions first ends 62 and (not numbered) are pivotally linked to the container 12 substantially adjacent the container bottom wall 22 so as to allow the first and second actuating arms side portions 56 and 58 to pivot with respect to the container 12. The interconnecting rod 63 extends between the first and second actuating arm side portion second ends 62 and (not numbered).

In some embodiments of the invention, the actuating arm 54 is manually operated. In other embodiments of the invention, the actuating arm 54 is connected to a motor (not shown in the drawings) and the motor operates the actuating arm 54.

The tarpaulin first biasing component 42 includes a first biasing lateral member 66 extending substantially laterally inwardly with respect to the body 14, and linking arm legs 68 and 70 extend substantially perpendicularly therefrom. In alternative embodiments of invention, the first biasing component 42 includes a two biasing lateral members 66 and 66′ extending substantially laterally inwardly with respect to the body 14, the tarpaulin 14 being inserted between the two biasing lateral members 66 and 66′. The second biasing component 42 includes a second biasing lateral member 72 extending substantially laterally inwardly with respect to the body 14 and linking arm legs 74 and 76 extending substantially perpendicularly therefrom. The first and second biasing lateral member 66 and 72 are receivable within the container 12.

The tarpaulin first biasing component 42 further includes linking members 78 and 80. The linking members 78 and 80 extend respectively substantially laterally outwardly from the first and second actuating arms side portions 56 and 58 locations intermediate their respective ends and are operatively coupled to the tarpaulin first biasing component 42 for moving the tarpaulin first biasing component 42 between the tarpaulin first biasing and releasing positions.

The second biasing component includes linking members 82 and (not shown). The linking members 82 and (not shown) are pivotally attached to the container 12 substantially adjacent the container bottom wall and are operatively coupled to the tarpaulin second biasing component 44 for moving the tarpaulin second biasing component 44 between the tarpaulin second biasing and releasing positions.

In use, the actuating arm 54 controls an amount of tarpaulin 14 that is withdrawn from the tarpaulin receiving implement 40. The actuating arm 54 therefore moves the tarpaulin 14 between the extended and retracted configurations.

In the extended configuration, as seen in FIGS. 2A and 2B, air 52 incoming onto the tarpaulin 14 when the vehicle 60 moves first dips into the container 12 towards the tarpaulin first concave section 28, thereby biasing the tarpaulin first concave section 28 towards the container bottom wall 22. Then, this air flows over the tarpaulin convex section 32 towards the tarpaulin second concave section 30, and the air exerts forces onto the tarpaulin 14 that bias the tarpaulin second concave section 30 towards the container bottom wall 22.

Although the present invention has been described hereinabove by way of preferred embodiments thereof, it can be modified, without departing from the spirit and nature of the subject invention as defined in the appended claims.

What is claimed is:

1. A device for maintaining a tarpaulin substantially in register with a top aperture of a container, the top aperture defining an aperture first end and a substantially opposed aperture second end, the container including a container bottom wall located substantially opposite the top aperture, the tarpaulin being configurable between a tarpaulin extended configuration and a tarpaulin retracted configuration, wherein, in the tarpaulin extended configuration, the tarpaulin is at least in part substantially in register with the top aperture, and in the tarpaulin retracted configuration, the tarpaulin is substantially retracted from the top aperture, the tarpaulin defining a tarpaulin first end and a substantially opposed tarpaulin second end, the tarpaulin first and second ends being respectively located substantially adjacent the aperture first and second ends when the tarpaulin is in the tarpaulin extended configuration, said device comprising:
a tarpaulin receiving implement located substantially adjacent the aperture first end, the tarpaulin receiving implement being mechanically coupled to the tarpaulin for receiving the tarpaulin when configuring the tarpaulin from the tarpaulin extended configuration to the tarpaulin retracted configuration and for releasing the tarpaulin when configuring the tarpaulin from the tarpaulin retracted configuration to the tarpaulin extended configuration; and
a tarpaulin biasing component mechanically coupled to the container and to the tarpaulin for biasing a tarpaulin section located substantially adjacent said tarpaulin second end such that said tarpaulin section is located substantially closer to the container bottom wall than the tarpaulin second end when the tarpaulin is in the tarpaulin extended configuration.

2. A device as defined in claim 1, wherein said tarpaulin biasing component creates a concavity in said tarpaulin section when the tarpaulin is in the tarpaulin extended configuration.

3. A device as defined in claim 2, wherein
said aperture first and second ends define a longitudinal direction leading from the aperture first end to the aperture second end; and
said concavity is configured such that when the tarpaulin is in the tarpaulin extended configuration and the container is moving through air in said longitudinal direction, the air exerts a force onto the tarpaulin that further biases the tarpaulin section towards the container bottom wall.

4. A device as defined in claim 3, wherein said concavity defines a nadir, said nadir being substantially longitudinally substantially closer to the aperture second end than the tarpaulin second end.

5. A device as defined in claim 4, wherein an angle between said container bottom wall and a portion of said tarpaulin extending between the tarpaulin second end and said nadir is from about 55 degrees to about 85 degrees.

6. A device as defined in claim 5, wherein said angle between said container bottom wall and said portion of said tarpaulin extending between the tarpaulin second end and said nadir is about 65 degrees.

7. A device as defined in claim 5, wherein a distance between said nadir and said container bottom wall is between about 50 percents and about 90 percents of a distance between said tarpaulin second end and said container bottom wall.

8. A device as defined in claim 7, wherein said distance between said nadir and said container bottom wall is about 80 percents of said distance between said tarpaulin second end and said container bottom wall.

9. A device as defined in claim 3, wherein
said tarpaulin biasing component is movable between a tarpaulin biasing position and a tarpaulin releasing position;
in said tarpaulin biasing position, said tarpaulin biasing component biases said tarpaulin section such that said tarpaulin section is located substantially closer to the container bottom wall than the tarpaulin second end;
in said tarpaulin releasing position, said tarpaulin biasing component releases said tarpaulin section such that the tarpaulin is movable towards the tarpaulin retracted configuration.

10. A device as defined in claim 9, further comprising a tarpaulin actuator mechanically coupled to the container and to the tarpaulin for moving the tarpaulin between the tarpaulin extended and retracted configurations, said tarpaulin actuator including a tarpaulin second end holder for holding the tarpaulin second end substantially adjacent the aperture second end when the tarpaulin is in the tarpaulin extended configuration.

11. A device as defined in claim 10, wherein said tarpaulin biasing component is operatively coupled to said tarpaulin actuator such that when said tarpaulin actuator moves said tarpaulin towards said tarpaulin extended configuration, said tarpaulin biasing component moves towards said tarpaulin biasing position.

12. A device as defined in claim 3, comprising
a tarpaulin first biasing component for biasing a tarpaulin first section located substantially adjacent said tarpaulin first end such that said tarpaulin first section is located substantially closer to the container bottom wall than the tarpaulin first end; and
a tarpaulin second biasing component for biasing a tarpaulin second section located substantially adjacent said tarpaulin second end such that said tarpaulin second section is located substantially closer to the container bottom wall than the tarpaulin first end;
wherein
said tarpaulin first and second biasing components are together movable between a tarpaulin biasing configuration and a tarpaulin releasing configuration;
in said tarpaulin biasing configuration, said tarpaulin biasing first and second components respectively bias said tarpaulin first and second sections such that said tarpaulin first and second sections are respectively located substantially closer to the container bottom wall than respectively the tarpaulin first and second ends;
in said tarpaulin releasing configuration, said tarpaulin first and second biasing components respectively release said tarpaulin first and second sections such that the tarpaulin is movable towards the tarpaulin retracted configuration; and
said tarpaulin first and second biasing components are operatively coupled to said tarpaulin actuator such that when said tarpaulin actuator moves said tarpaulin towards said tarpaulin extended configuration, said tarpaulin first and second biasing component move towards said tarpaulin biasing configuration.

13. A method for maintaining a tarpaulin substantially in register with a top aperture of a container carried by a forwardly moving vehicle moving through air, the top aperture defining an aperture rear end and a substantially opposed aperture front end, the container including a container bottom wall located substantially opposite the top aperture, the tarpaulin defining a tarpaulin front end and a substantially opposed tarpaulin rear end, said method comprising:
extending the tarpaulin substantially across the top aperture such that the tarpaulin front end is located substantially adjacent the aperture front end and the tarpaulin rear end is located substantially adjacent the tarpaulin rear end; and
biasing a tarpaulin section located substantially adjacent the tarpaulin rear end such that said tarpaulin section is located substantially closer to the container bottom wall than the tarpaulin second end.

14. A method as defined in claim 13, further comprising moving the vehicle through the air in a direction substantially parallel to a direction leading from the aperture rear end to the aperture front end so that the air creates a force onto the tarpaulin that further biases the tarpaulin section towards the container bottom wall.

15. An assembly for carrying a load, said assembly comprising:
a container for containing the load, said container defining a top aperture, said top aperture defining an aperture first end and a substantially opposed aperture second end, said container including a container bottom wall located substantially opposite said top aperture; and
a substantially elongated tarpaulin attached to said container and extending at least in part substantially in register with said top aperture, said tarpaulin defining
a tarpaulin first end and a substantially longitudinally opposed tarpaulin second end, said tarpaulin first end being located substantially adjacent said aperture first end and said tarpaulin second end being located substantially adjacent said aperture second end;
a tarpaulin first concave section located substantially adjacent said tarpaulin first end, said tarpaulin first concave section being located substantially closer to said container bottom wall than said tarpaulin first end;
a tarpaulin second concave section located substantially adjacent said tarpaulin second end, said tarpaulin second concave section being located substantially closer to said container bottom wall than said tarpaulin second end; and
a tarpaulin convex section located between said tarpaulin first and second concave sections.

16. An assembly as defined in claim 15, wherein said tarpaulin second concave section defines a nadir, said nadir being substantially longitudinally substantially closer to said aperture second end than said tarpaulin second end.

17. A device as defined in claim 16, wherein an angle between said container bottom wall and a portion of said tarpaulin extending between said tarpaulin second end and said nadir is from about 55 degrees to about 85 degrees.

18. A device as defined in claim 16, wherein said tarpaulin is substantially planar between said nadir and said tarpaulin second end.

19. An assembly as defined in claim 15, wherein said tarpaulin convex section is substantially arc segment shaped.

20. An assembly as defined in claim 15, wherein said container contains the load and wherein said tarpaulin convex section abuts against the load.
